(19) United States
(12) Patent Application Publication
(10) Pub. No.: US 2013/0340272 A1
(43) Pub. Date: Dec. 26, 2013

(54) DEVELOPMENTS IN OR RELATING TO HAND DRYING

(71) Applicants: Stephen Benjamin COURTNEY, Malmesbury (GB); Patrick Joseph William Moloney, Malmesbury (GB); Christopher Lesniowski, Malmesbury (GB)

(72) Inventors: Stephen Benjamin COURTNEY, Malmesbury (GB); Patrick Joseph William Moloney, Malmesbury (GB); Christopher Lesniowski, Malmesbury (GB)

(73) Assignee: DYSON TECHNOLOGY LIMITED, Malmesbury (GB)

(21) Appl. No.: 13/528,371

(22) Filed: Jun. 20, 2012

(51) Int. Cl. F26B 19/00

(52) U.S. Cl. 34/90

(57) ABSTRACT

A fixture arranged in combination with a sink. The fixture is fitted next to the basin of the sink and incorporates a part which projects over the basin of the sink, this projecting part carrying a water nozzle which is connected to a water supply. The arrangement further incorporates a hand dryer of the type which uses an air-knife mechanically to wipe the water from a user's hand, this air knife being discharged through a discharge outlet on the fixture, which apertures are connected to an air supply.

### FIELD OF THE INVENTION

The present invention relates generally to the field of hand drying and in particular to arrangements which use an air-knife to dry the hands.

### BACKGROUND OF THE INVENTION

In commercial washrooms, it is common to provide one or more sinks or water basins for washing, and one or more separate, wall-mounted hand-dryers which users can then use to dry their hands.

Generally speaking, there are several types of hand dryer on the market. One type of hand dryer is the air-knife hand dryer, examples of which include the Dyson Airblade® range of hand dryers manufactured by Dyson (UK) Limited and the Jet Towel® range of hand dryers manufactured by Mitsubishi Electric Corporation.

These hand dryers use an air-knife—effectively a sheet or curtain of moving air—to remove the water from the user's hands. The mode of operation is analogous to the established use of air knives in industry to remove debris or liquid from the surface of a product (see e.g. EP2394123A1, which describes removal of debris from a glass sheet using air knives): the air-knife moves across the surface of the hand and, as it does so, wipes or scrapes the water from the surface of the hand.

In both the Dyson Airblade and the Mitsubishi Jet Towel, two opposing, stationary air-knives are used, one for each side of the user's hand. The hands are inserted between the air-knives and then withdrawn slowly to effect the required relative movement between the hands and the air knives.

In the Dyson arrangement—shown in FIG. 1—the air knives are discharged through narrow, continuous slots (only the rear slot a is visible in FIG. 1), each less than 1 mm wide.

In the Mitsubishi machine—shown in FIG. 2—the air-knife is instead discharged through opposing rows of individual discharge apertures (only the rear row b is visible in FIG. 2): here, the individual jets combine to produce the air knife downstream of the discharge apertures. In each case, the air knife is discharged at high speed (>80 m/s) to provide for an efficient wiping action across the surface of the hand.

### SUMMARY OF THE INVENTION

According to the present invention, there is provided an arrangement comprising a fixture in combination with a sink, the fixture being fitted next to the basin of the sink and comprising a part which projects over the basin of the sink, this projecting part carrying a water nozzle which is connected to a water supply, the arrangement further incorporating a hand dryer of the type which uses an air-knife mechanically to wipe the water from a user's hand, the air knife being discharged through an elongate air-knife discharge outlet on the fixture which are connected to an air supply.

One of the problems identified with air-knife dryers is that of managing the disposal of waste water. This is a problem for air-knife dryers because the nature of the air-knife drying mechanism means that the water removal is non-evaporative: instead, the water is driven from the hands by the relatively high momentum of the airflow. In the conventional air-knife dryer arrangements described above, the waste water removed from the hands may be collected in a drip tray—which must periodically be emptied—or else is not collected at all and instead simply allowed to evaporate from surfaces on and around the dryer. Neither scheme is particularly hygienic.

The invention advantageously makes use of the existing mains drainage system to manage the waste water more effectively: by incorporating the air-knife dryer on a fixture for a sink so that water driven from the hands can simply drain to mains through the standard drain-hole in the basin of the sink.

The discharge outlet may be arranged to span the width of a user's hand, so that the air-knife provides a wiping action the full width of the user's hand. A lateral span of at least 80 mm is considered sufficient in most cases. If it is intended to dry both hands at the same time, then the discharge outlet may be arranged to span the width of both hands held side-by-side. A lateral span of at least 200 mm is considered preferable in this case, though again this is not essential—a shorter span may be suitable for certain users.

The air supply is preferably configured to discharge the air-knife through the discharge outlet at an exit airspeed which exceeds 80 m/s. This ensures that the air knife has an effective wiping action at the surface of the hands. A particularly effective wiping action can be obtained at airspeeds in excess of 150 m/s. The exit air speed is determined in accordance with general air knife principles by the discharge area and the pressure behind the discharge outlet. So, for example, increasing the discharge area will reduce the exit air speed at a given pressure. Increasing the pressure for a given discharge area will increase the exit air speed.

The discharge outlet may take the form of air holes arranged in a row or, alternatively, an elongate air slot. For example a single elongate air slot or row of air holes may be provided to discharge a single air-knife for drying the hands one after another; a pair of such slots or rows of holes may be provided for generating two separate air-knives which dry both hands—or both sides of a single hand—simultaneously, or a single elongate slot or row of holes may be provided for generating a single air knife which is sufficiently long to dry the hands simultaneously side-by-side.

The individual air holes themselves may be slot-like. Where air slots are used, these slots may be less than 2 mm wide, intended to provide a laminar, well-defined air knife with minimal wind shear.

In one embodiment, the length of the slot—or length of the row of air holes—is at least 80 mm.

The discharge outlet may be provided on a respective branch duct which extends laterally from the projecting part. In one embodiment, there are two discharge outlets—for generating two respective air-knives—which outlets are arranged along two respective branch ducts extending laterally either side of the projecting part.

The discharge apertures may be connected to the air supply via the projecting part. Similarly, the water nozzle may be connected to the water supply via the projecting part. For example, an air duct may be provided through the projecting part which connects to the discharge outlet(s). A water supply line may then be provided running through the air duct to the water nozzle.

In one arrangement a sensor is provided for detecting the presence of user's hands. The sensor is connected to an actuator for automatically dispensing water and/or discharging air in response to detection of a user's hands. This arrangement has the advantage that the user does not have to touch the fixture at any point during operation, so that use of the fixture is more hygienic.

According to another aspect of the invention, there is provided an arrangement comprising a fixture in combination with a sink, the fixture being fitted next to the basin of the sink and comprising a water spout arranged to project over the basin of the sink, the water spout having a water nozzle connected through the spout to a water supply, the arrangement further incorporating a hand dryer for directing air onto the hands of a user, the air being directed through a discharge outlet, the discharge outlet being connected to a source of pressurized air which in use drives the air through the discharge outlet at a speed exceeding 80 m/s.

According to a third aspect of the invention, there is provided an arrangement comprising a fixture in combination with a sink, the fixture being fitted next to the basin of the sink and comprising a water spout arranged to project over the basin of the sink, the water spout having a water nozzle connected through the spout to a water supply, the arrangement further incorporating a hand dryer for directing air onto the hands of a user to dry them, the air being directed through a discharge outlet, the discharge outlet spanning a width of at least 80 mm.

Similarly, there may be provided a fixture for fitting next to the basin of a sink, the fixture comprising a water spout arranged to project over the basin of the sink, the water spout having a water nozzle arranged for connection through the spout to a water supply, the fixture further comprising a discharge outlet arranged for connection to a source of pressurized air, the discharge outlet spanning a width of at least 80 mm.

### BRIEF DESCRIPTION OF THE DRAWINGS

Embodiments of the invention will now be described with reference to the accompanying drawings, in which:

FIG. 1 is a perspective view of a first, conventional air knife hand dryer;

FIG. 2 is a perspective view of a second, conventional air-knife hand dryer;

FIG. 3 is a perspective view of an arrangement according to the present invention;

FIG. 4 is a front view of the arrangement shown in FIG. 3;

FIG. 5 is a section view along A-A in FIG. 4;

FIG. 6 is a view from the front of the fixture in FIGS. 3 to 5, illustrating the fixture in use;

FIG. 7 is a perspective view of an alternative, “single-sided” arrangement in accordance with the invention;

FIG. 8 is a perspective view of another alternative arrangement, illustrating ducting of air along the outside of a spout forming part of the fixture; and

FIG. 9 is a perspective view of an arrangement in accordance with the invention, in which the fixture is mounted on a wall above the sink.

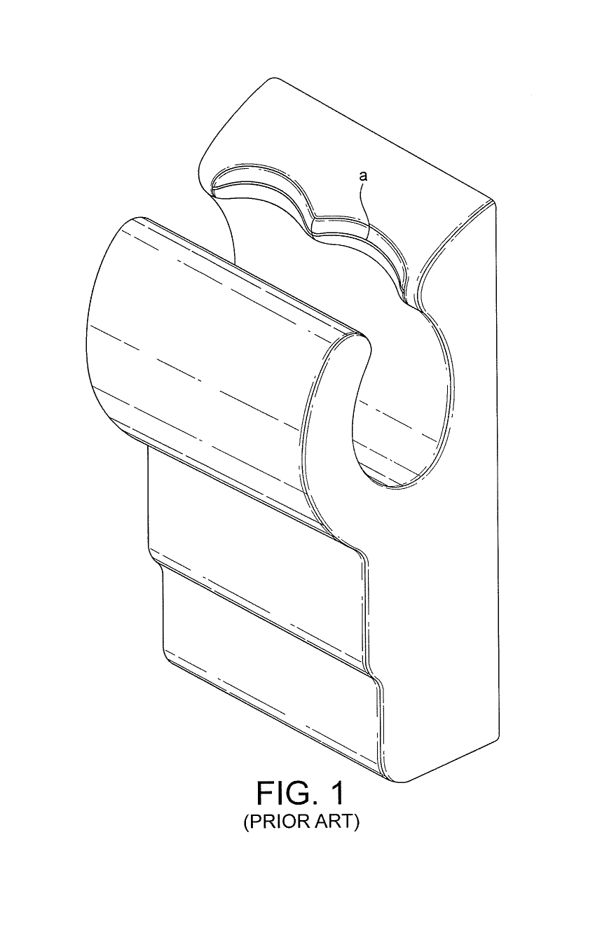

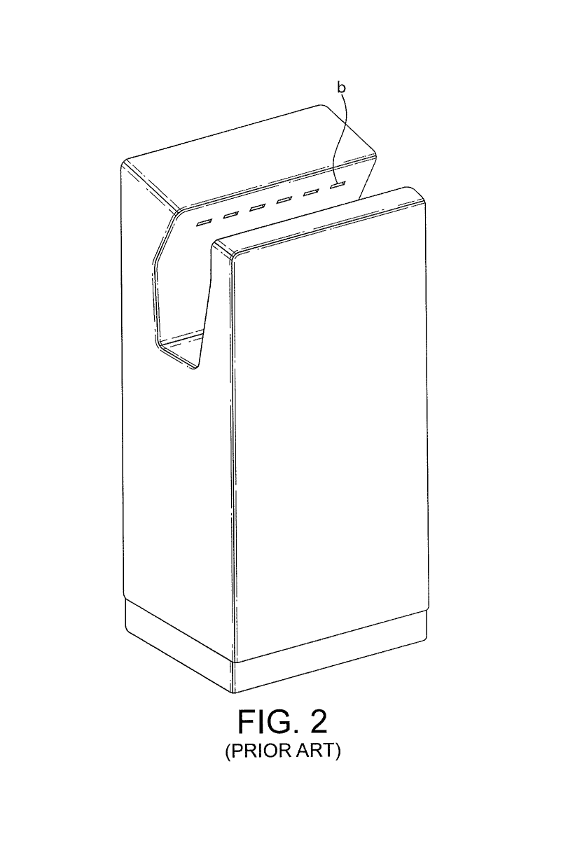

### DETAILED DESCRIPTION OF THE INVENTION

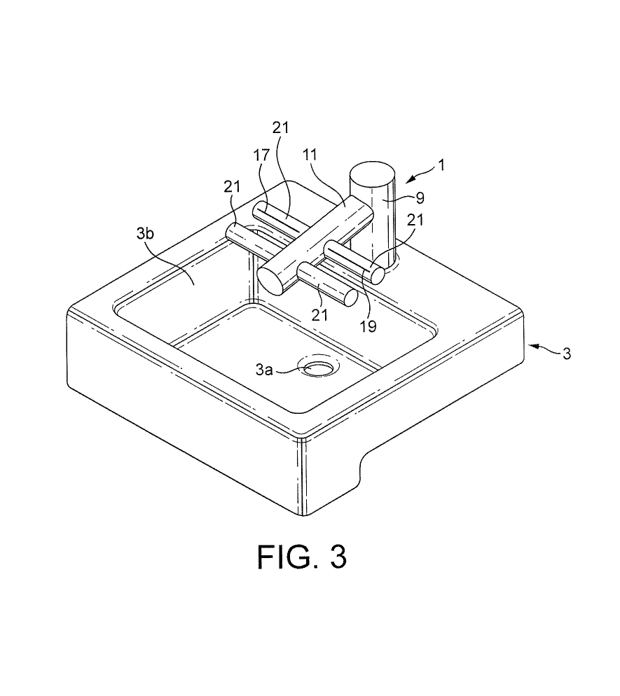

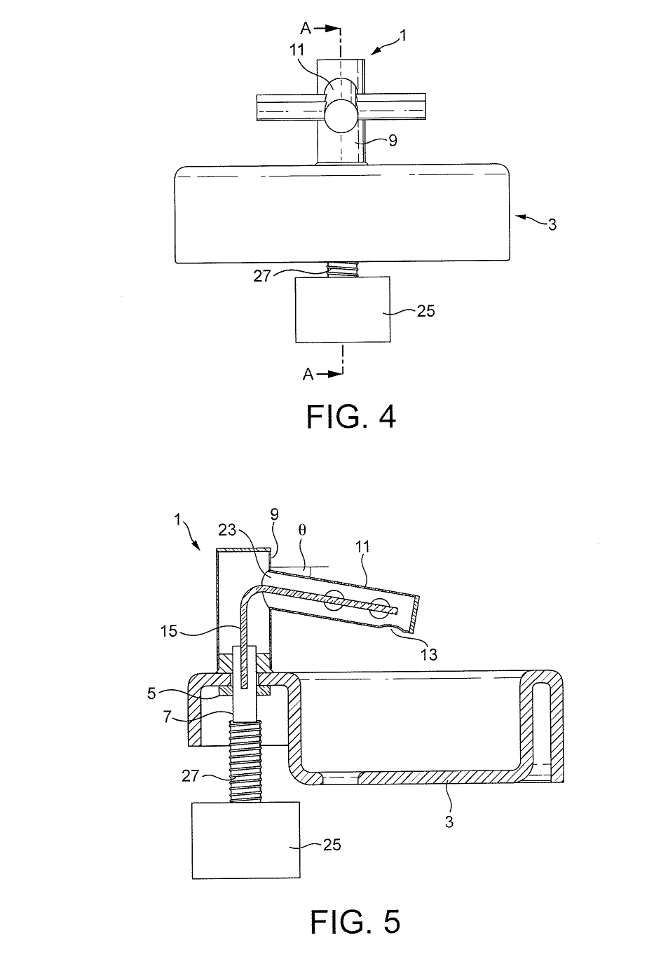

FIGS. 3-5 show an arrangement comprising a fixture 1 in combination with a sink 3.

The sink 3 itself may be conventional. A “Belfast-type” sink is shown, though other types of sink may alternatively be used. The sink 3 has a standard drain-hole 3a, in this case positioned towards the rear wall of the basin 3b of the sink 3.

The fixture 1 is fitted next to the basin 3b of the sink 3 using a locknut 5 underneath the sink 3 which engages with an externally threaded, hollow fixing stud 7 to clamp the fixture 1 in place (the fixture 1 may alternatively be fitted adjacent the sink rather than to the sink itself, according to the style of sink).

The fixture 1 has a tubular construction comprising a vertical, tubular trunk 9 which sits next to the basin 3b of the sink 3 and a projecting part, in the form of a spout 11, which projects horizontally from the trunk 9, out over the basin 3b of the sink 3. The fixture 1 is formed from metal: for example from conventional rolled steel tubing sections which are then welded together.

A downward facing water nozzle 13 is provided at the end of the spout 11. On demand, water for washing is supplied through the water nozzle 13 from a main supply line (not shown), via a water supply pipe 15 which runs through the trunk 9 and the spout 11.

The fixture 1 is configured for “hands-free” operation to supply water, using a conventional sensor and control loop which automatically opens a stop valve in the supply line, in response to detection of a user's hands in a washing position. Alternatively, the fixture may be configured for manual operation to supply water.

In accordance with the invention, the fixture 1 incorporates a hand dryer of the type which uses an air-knife mechanically to wipe the water from a user's hand. In this case, two opposing pairs of air-knives are discharged in use. The first pair of air-knives is discharged through a respective opposing pair of discharge outlets 17 (only one of which is visible in FIG. 3) on the left-hand side of the spout 11. The second pair of air-knives is discharged through a respective opposing pair of discharge outlets 19 (only one of which is visible in FIG. 3) on the right-hand of the spout 11. Each discharge outlet 17, 19 takes the form of a narrow elongate slot—less than 2 mm wide—extending laterally from the spout 11 along a respective tubular branch duct 21.

The branch ducts 21—four in total—branch off from a main air duct 23 which runs through the spout 11 and the trunk 9. This air duct 23 is connected to the positive pressure (output) side of a motor-driven fan 25 via a flexible hose 27 which fluidly connects to the inside of the trunk 9 via the hollow fixing stud 7 (if the water supply pipe 15 runs through the fixing stud 7—effectively within the air supply line—then adequate provision will need to be made to route the pipe 15 to the exterior of the air supply line, for connection to the water supply line).

On demand, the fan 25 drives airflow through the discharge outlets 17, 19 to generate the respective opposing pairs of air-knives. The exit airspeed at the discharge outlets 17, 19 exceeds 80 m/s, and is preferably above 150 m/s. This provides in each case a well-defined air-knife for effective drying of the hands.

The hand dryer is configured for “hands-free” operation using a conventional sensor and control loop, which automatically switches on the fan 25 in response to detection of a user's hands in a drying position (which should be distinguishable from the aforementioned washing position—which automatically activates the water supply). Alternatively, the hand dryer may be configured for manual operation.

In use, a user can perform both washing and hand-drying operations at the sink:

To commence the washing operation, the user places his (or her) hands underneath the water nozzle 13 as if to wash his hands, and the sensor and control loop operates to deliver water through the water nozzle 13. The user can then proceed to wash his hands in conventional manner over the basin 3b of the sink 3.

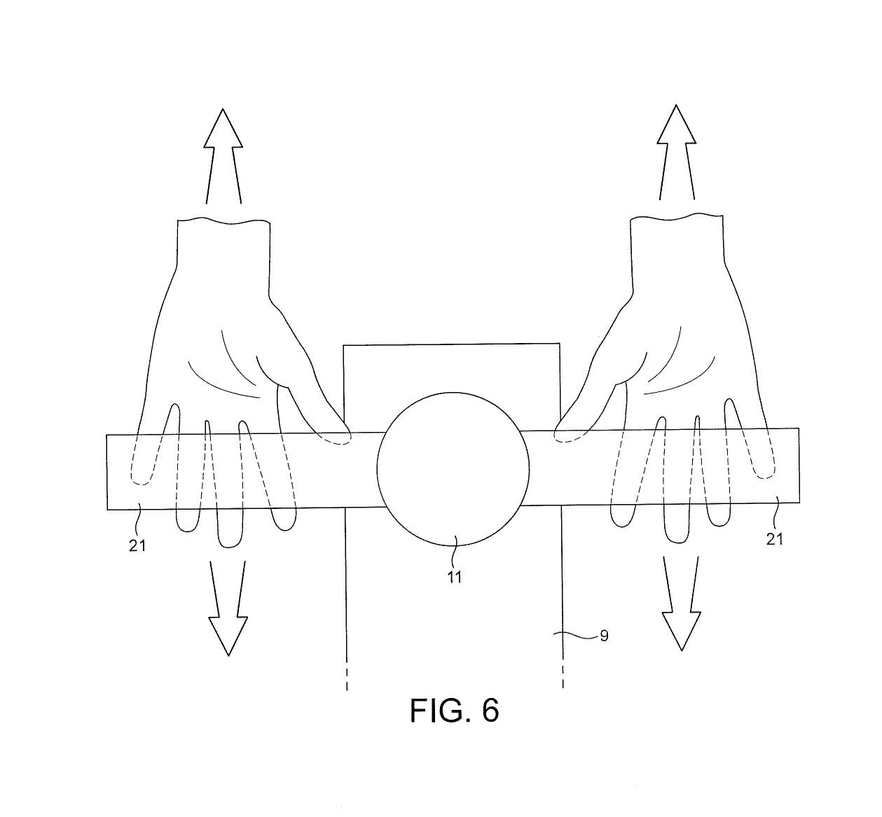

To commence the hand-drying operation, a user dips his wet left-hand—palm open—between the opposing pair of discharge outlets 17, 19 on the left-hand side of the spout and, at the same time, dips his wet right-hand—palm open—between the opposing pair of discharge outlets 17, 19 on the right hand of the spout 11. The sensor and control loop then operates to activate the fan 25, which forces air under high pressure through the discharge outlets 17, 19: directing high-momentum airflow onto the front and backs of the user's hands. To dry his hands, the user then makes one or more generally ‘vertical’ passes between the opposing pairs of discharge outlets 17, 19—palms held open—and the high momentum airflow strips water from the surface of the user's hands. The general dipping action of the hands is illustrated in FIG. 6 (here, looking axially along the spout 11 from the front).

The branch ducts 21 lie in generally the same plane as the spout 11, which extends downwardly towards the user at an angle θ (FIG. 5) in the range 5 to 15 degrees, preferably 10 degrees. Thus, rather than the user having to dip his hands vertically between opposing pairs of discharge outlets 17, 19, the hand entry-angle is tilted towards the user to make the dipping action more comfortable.

The waste water driven from the hands is conveniently collected in the basin 3b of the sink 3, where it may drain to the mains through the conventional plumbing system for the sink 3.

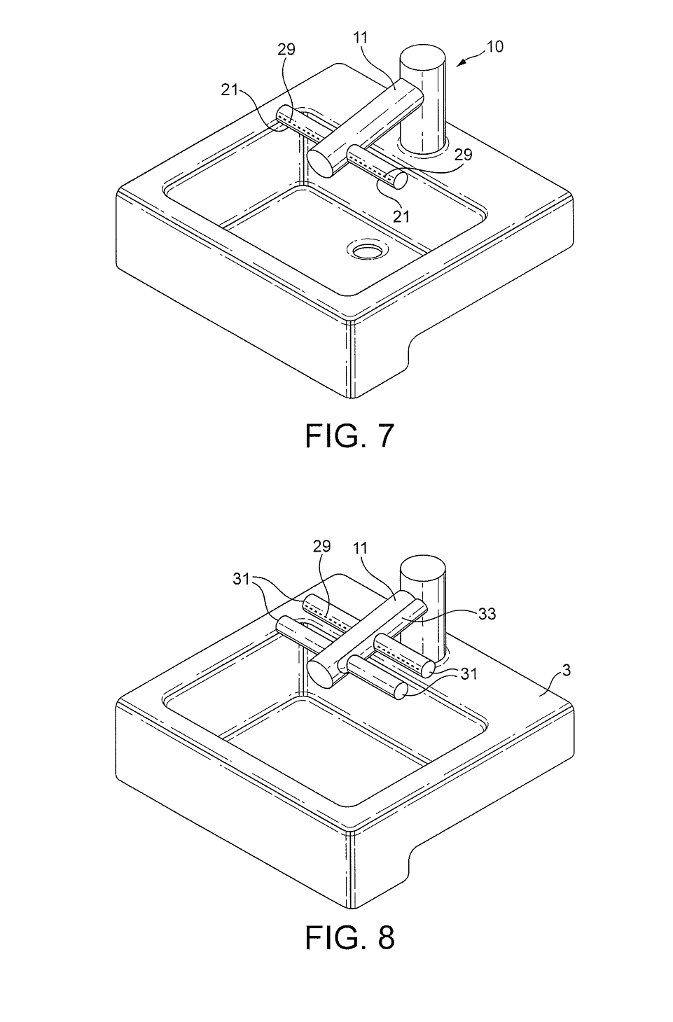

The use of opposing pairs of discharge apertures to generate opposing air-knives is not essential. FIG. 7 shows a “single-sided” arrangement in which the fixture 10 comprises two branch ducts 21, not four. A discharge outlet in the form of a row of discharge apertures 29—in this case circular air holes, not slots—is provided along each branch duct 21. In use, the individual air jets discharged through the discharge apertures 29 combine downstream of the discharge apertures 29 to form two separate air-knives: a first air-knife to the left hand side of the spout 11 and a second air knife to the right-hand side of the spout 11.

FIG. 8 shows an arrangement in which the branch ducts 31 do not connect to the air supply through the spout, specifically. Instead, separate air ducts (only one of which is visible in FIG. 8) are provided which connect opposing branch ducts 31 to the pressure side of an air supply (not shown). Again, the air-knives—in this case four in total—are discharged through discharge outlets which take the form of rows of air holes 29, not slots, in common with the arrangement in FIG. 7.

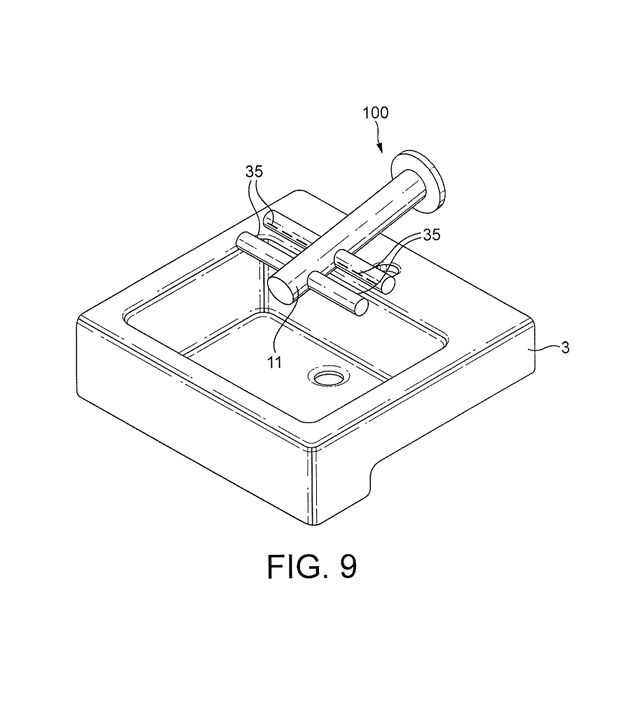

The fixture does not need to mount to the sink itself. FIG. 9 shows a wall-mounted fixture 100 in accordance with the invention. Here, each air-knife—four in total—is discharged through a respective discharge outlet comprising a row of elongate air slots 35 (only two rows are visible in FIG. 9).

1. An arrangement comprising a fixture in combination with a sink, the fixture being fitted next to the basin of the sink and comprising a part which projects over the basin of the sink, this projecting part carrying a water nozzle which is connected to a water supply, the arrangement further incorporating a hand dryer of the type which uses an air-knife mechanically to wipe the water from a user's hand, the air knife being discharged through an elongate air-knife discharge outlet on the fixture which is connected to an air supply.

2. The arrangement according to claim 1, in which the elongate air-knife discharge outlet is in fixed position on the fixture.

3. The arrangement according to claim 1, wherein the air-knife discharge outlet comprises one or more elongate air-slots.

4. The arrangement according to claim 2, wherein the individual air-slots are less than 2 mm wide.

5. The arrangement according to claim 1 or 2, wherein the discharge outlet is provided on a respective branch duct which extends laterally from the projecting part.

6. The arrangement according to claim 3, wherein the fixture comprises two discharge outlets, arranged on two respective branch ducts, one extending laterally either side of the projecting part.

7. The arrangement according to claim 6, in which the branch ducts are cylindrical.

8. The arrangement according to claim 5, wherein the respective discharge outlet on each branch duct spans at least 80 mm.

9. The arrangement according to claim 1, in which the discharge outlet is connected to the air supply via the projecting part.

10. The arrangement according to claim 1 or 9, wherein the water nozzle is connected to the water supply via the projecting part.

11. The arrangement according to claim 1, in which the air supply is configured to discharge air through the discharge outlet at an exit velocity of at least 80 m/s.

12. The arrangement according to claim 1, comprising a sensor for detecting the presence of user's hands and an actuator for automatically dispensing water and/or discharging air in response to detection of a user's hands.

13. An arrangement comprising a fixture in combination with a sink, the fixture being fitted next to the basin of the sink and comprising a water spout arranged to project over the basin of the sink, the water spout having a water nozzle connected through the spout to a water supply, the arrangement further incorporating a hand dryer for directing air onto the hands of a user, the air being directed through a discharge outlet, the discharge outlet being connected to a source of pressurized air which in use drives the air through the discharge outlet at a speed exceeding 80 m/s.

14. An arrangement comprising a fixture in combination with a sink, the fixture being fitted next to the basin of the sink and comprising a water spout arranged to project over the basin of the sink, the water spout having a water nozzle connected through the spout to a water supply, the arrangement further incorporating a hand dryer for directing air onto the hands of a user to dry them, the air being directed through a discharge outlet, the discharge outlet spanning a width of at least 80 mm.

15. A fixture for fitting next to the basin of a sink, the fixture comprising a water spout arranged to project over the basin of the sink, the water spout having a water nozzle arranged for connection through the spout to a water supply, the fixture further comprising a discharge outlet arranged for connection to a source of pressurized air, the discharge outlet spanning a width of at least 80 mm.
